(19) United States
(12) Patent Application Publication
(10) Pub. No.: US 2018/0233809 A1
(43) Pub. Date: Aug. 16, 2018

(54) GNSS SIGNAL RECEIVING ANTENNA

(71) Applicant: Pacific Telecom & Navigation (Shenzhen) Limited, Shenzhen (CN)

(72) Inventor: Lei Ye, Hongkou District (CN)

(73) Assignee: Pacific Telecom & Navigation (Shenzhen) Limited, Shenzhen (CN)

(21) Appl. No.: 15/954,113

(22) Filed: Apr. 16, 2018

Related U.S. Application Data
(63) Continuation of application No. PCT/CN2015/094524, filed on Nov. 13, 2015.

(30) Foreign Application Priority Data
Oct. 19, 2015 (CN) 2015208117579

(51) Int. Cl. H01Q 1/24; H01Q 1/38; H01Q 21/06

(52) U.S. Cl. CPC H01Q 1/247; H01Q 21/061; H01Q 1/38

(57) ABSTRACT

In a GNSS signal receiving antenna, a radiation pattern of an antenna unit of the antenna includes four sub-patterns that form a rectangular shape and each of the sub-patterns comprises a first part, a second part and a third part communicated with each other. The first part is communicated with the second part and the second part is communicated with the third part. The four sub-portions form a rectangular shape with an end portion of the third part of each sub-pattern disposed opposite to a side portion of the first part of a next adjacent sub-pattern. The four sub-patterns are not communicated with each other. The GNSS signal receiving antenna can receive both a traditional right-handed circularly polarized signal and a left-handed circularly polarized signal. Multiple antenna units may form an array antenna for directional GNSS signal reception.

### CROSS-REFERENCE TO RELATED PATENT APPLICATIONS

The present application is a continuation of International Application No. PCT/CN2015/094524, filed Nov. 13, 2015, which claims the benefit of priority to Chinese Application No. CN 2015208117579, filed on Oct. 19, 2015, the content of which is incorporated herein by reference in its entirety.

### FIELD OF THE INVENTION

The present application relates to the field of electromagnetic field and microwave technology, and in particular to a GNSS signal receiving antenna.

### BACKGROUND

The Global Navigation Satellite System (GNSS) refers to all satellite navigation systems, including global, regional, and augmented satellite navigation systems, such as GPS in the United States, Glonass in Russia, Galileo in Europe, the BeiDou satellite navigation system in China and related augmentation systems.

A GNSS antenna is mainly used as a transmitting antenna or a receiving antenna in a same-frequency retransmission system. The antenna is composed of a radome, a microstrip radiator, a baseplate and a high-frequency output socket and so on and is used for GPS navigation and positioning systems as a receiving antenna. The commonly used GNSS receiving antenna pattern basically realizes a hemispherical radiation. The existing GNSS receiving antennas are all omnidirectional antennas and can only receive right-handed circularly polarized signals.

### SUMMARY OF THE INVENTION

In view of this, the present disclosure provides a GNSS signal receiving antenna that can be formed as both an omnidirectional antenna and a directional antenna, and can receive both a conventional right-handed circularly polarized signal and a left-handed circularly polarized signal.

The GNSS signal receiving antenna of the present disclosure comprises:

at least one antenna unit, wherein the antenna unit comprises: a substrate; a radiation pattern formed on a first surface of the substrate, including four sub-patterns that forms a rectangular shape; and a feed pattern formed on a second surface of the substrate;

a low-noise amplifier connected to the feed pattern of the antenna unit;

wherein each of the sub-patterns comprises a first part, a second part and a third part communicated with each other, the first part is communicated with the second part and the second part is communicated with the third part, the first part and the third part are symmetrically disposed with respect to the second part and have an identical rectangular shape, an end portion of the third part of each sub-pattern is disposed opposite to a side portion of the first part of a next adjacent sub-pattern so that the four sub-patterns form a rectangular shape, and the four sub-patters are not communicated with each other.

In one embodiment, the second part has a rectangular shape.

In one embodiment, a width of the second part is less than that of the first part and the third part.

In one embodiment, the axes of the first part, the second part and the third part of the sub-pattern are arranged in a line.

In one embodiment, the feed pattern is at least partially disposed at a position corresponding to an underside of the first part of each sub-pattern.

In one embodiment, the sub-patterns are hollow out patterns, and the feed pattern is a conductive pattern.

In one embodiment, the antenna comprises one said antenna unit and is an omnidirectional antenna.

In one embodiment, the antenna comprises four said antenna units arranged in an array and is a directional antenna.

By arranging the radiation pattern as four sub-patterns that form a rectangular shape and the end portion of the third part of each sub-pattern is disposed opposite to a side portion of the first part of a next adjacent sub-pattern, the antenna can receive both a traditional right-handed circularly polarized signal and a left-handed circularly polarized signal. The antenna can have a very strong directionality by arranging the antenna units in an array and can be networked according to the requirements of a phased array sequence to meet different high-tech requirements of receiving and processing of the GNSS signal.

It is disclosed a GNSS signal receiving antenna. A radiation pattern of an antenna unit of the antenna includes four sub-patterns that form a rectangular shape and each of the sub-patterns comprises a first part, a second part and a third part communicated with each other. The first part is communicated with the second part and the second part is communicated with the third part. The first part and the third part are symmetrically disposed with respect to the second part and have an identical rectangular shape. An end portion of the third part of each sub-pattern is disposed opposite to a side portion of the first part of a next adjacent sub-pattern so that the four sub-patterns form a rectangular shape, and the four sub-patters are not communicated with each other. In this way, the GNSS signal receiving antenna can receive both a traditional right-handed circularly polarized signal and a left-handed circularly polarized signal. Furthermore, multiple antenna units can be used to form an array antenna to enable a directional reception of a GNSS signal.

### BRIEF DESCRIPTION OF THE DRAWINGS

The above and other objectives, features, and advantages of the present disclosure will become much clearer through following description of the embodiments of the present disclosure with reference to the accompanying drawings, wherein:

FIG. 1 is a side view of a GNSS signal receiving antenna according to a first embodiment of the present disclosure;

FIG. 2 is a schematic diagram of an antenna unit according to the embodiment of the present disclosure;

FIG. 3 is a schematic diagram of a radiation pattern of the antenna unit according to the embodiment of the present disclosure;

FIG. 4 is a frequency characteristic diagram of the antenna unit according to the embodiment of the present disclosure;

FIGS. 5a-5c are patterns of the GNSS signal receiving antenna according to a first embodiment of the present disclosure;

FIG. 6 is a front view of a GNSS signal receiving antenna according to a second embodiment of the present disclosure;

FIG. 7 is a side view of the GNSS signal receiving antenna according to the second embodiment of the present disclosure;

FIG. 8 is a frequency characteristic diagram of an antenna unit according to the embodiment of the present disclosure, and

FIGS. 9a-9c are antenna patterns of the GNSS signal receiving antenna according to the second embodiment of the present disclosure.

### PREFERRED EMBODIMENTS OF THE PRESENT INVENTION

The present disclosure will be described below based on the embodiments. However, the present disclosure is not limited to these embodiments. In the detailed description of the present disclosure hereinafter, some specific details will be described exhaustively. For those skilled in the art, the present disclosure may be thoroughly understood without description of these details. In order to avoid confusing the substance of the present disclosure, known methods, processes, flows, elements and circuits will not be described in detail.

In addition, a person of normal skill in the art should understand the drawings provided here are for illustrative purposes, and the drawings are not necessarily drawn in proportion.

Unless explicitly required in the context, the terms “comprise” and “include” and like expressions in the entire description and claims should be interpreted as an inclusive meaning, not an exclusive or exhaustive meaning; in other words, they mean “include, but not limited to.”

In the description of the present disclosure, it should be understood that the terms “first” and “second” are only for descriptive purposes, and cannot be understood as indicating or implying relative importance. In addition, in the description of the present disclosure, unless otherwise indicated, the meaning of “plural” is two or above.

FIG. 1 is a side view of a GNSS signal receiving antenna according to a first embodiment of the present disclosure.

As shown in FIG. 1, the GNSS signal receiving antenna of the present embodiment comprises an antenna unit 1, a low-noise amplifier 2 and a support component 3.

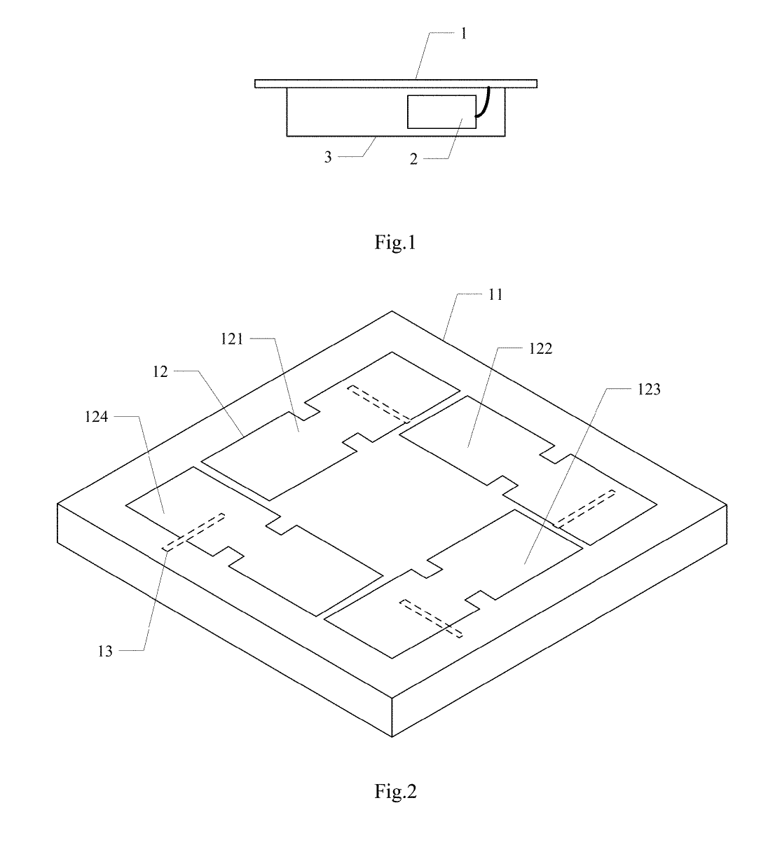

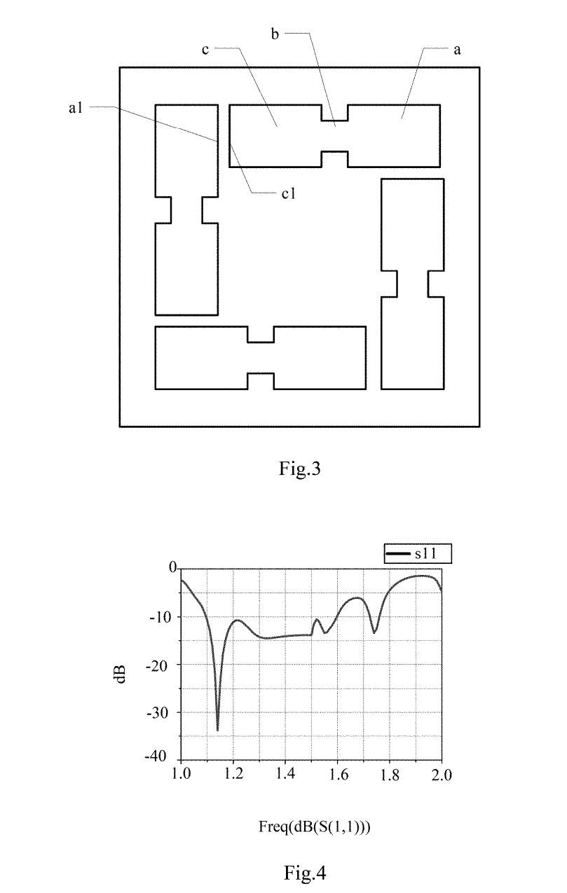

FIG. 2 is a schematic diagram of the antenna unit according to the embodiment of the present disclosure. FIG. 3 is a schematic diagram of a radiation pattern of the antenna unit according to the embodiment of the present disclosure.

As shown in FIGS. 2 and 3, the antenna unit 1 comprises a substrate 11, a radiation pattern 12 and a feed pattern 13. The substrate 11 may be generally formed of a material such as ceramic, FR-4 material, polytetrafluoroethylene, epoxy resin, silicon dioxide. The radiation pattern 12 is formed on a first surface of the substrate 11 and comprises four sub-patterns 121, 122, 123, and 124 that form a rectangular shape.

Wherein each of the sub-patterns comprises a first part a, a second part b and a third part c communicated with each other. The first part a is communicated with the second part b and the second part b is communicated with the third part c. The first part a and the third part c are symmetrically disposed with respect to the second part b and have an identical rectangular shape. The axes of the first part a, the second part b and the third part c are arranged in a line. In the present embodiment, the second part b is also formed to have a rectangular shape with a width less than that of the first part a and the third part c, so that the sub-patterns 121-124 are respectively formed to be dumbbell-like patterns composed of rectangles. In the present embodiment, the sub-patterns 121-124 are hollowed out patterns formed on a conductive material layer. The conductive material may be a metal conductive material such as gold, silver or copper, or may be an oxide conductive material such as ITO.

The four sub-patterns 121-124 form a rectangle in a circular manner in their mutual position arrangement. Specifically, an end portion of a side of one sub-pattern is disposed opposite to a portion of a side of a next adjacent sub-pattern that is close to the end of the side.

More specifically, an end portion c1 of the third part c of each sub-pattern is disposed opposite to a side portion al of the first part a of the next adjacent sub-pattern so that the four sub-patterns form a rectangular shape and the four sub-patterns are not communicated with each other.

The thus-formed antenna unit can receive both a right-handed circularly polarized signal and a left-handed circularly polarized signal. Thus, the GNSS signal receiving antenna of the present embodiment forms a GNSS-R receiving antenna or a GNSS-L receiving antenna through one said antenna unit.

At the same time, the feed pattern 13 is disposed on a second surface of the substrate 11 opposite to the first surface thereof and at least comprises a conductive pattern located at a position corresponding to the first part a of each sub-pattern.

The low-noise amplifier 2 is electrically connected to the feed pattern 13, receives a GNSS electromagnetic signal received via the radiation pattern, amplifies the received signal and transmits the amplified signal to a signal processing system connected to the GNSS receiving antenna. In one embodiment, the low-noise amplifier 2 can be a low-noise amplifier using an SMA interface.

The support component 3 is used as a carrier for mounting the antenna unit 1 and the low-noise amplifier 2. The low-noise amplifier 2 is mounted at a side of the supporting component 3 and the antenna unit 1 is mounted on a corresponding mounting surface of the supporting component 3 in an insulated manner. The supporting component 3 can be made of aluminum alloy material.

In a preferred embodiment, the indexes of the antenna unit are as below:

(1) Frequency Range: GPS L1/L2, BD2 B1/B2/B3

(2) Impedance: 50Ω

(3) Antenna axial ratio: ≤3 dB

(4) Output standing wave (VSWR): ≤1.5

(5) Interface: SMA

The size of the antenna unit may be 280 mm×280 mm×53 mm and the number is one.

The indexes adopted by the low-noise amplifier 2 are as below:

(1) Frequency Range: GPS L1/L2, BD2 B1/B2/B3

(2) LNA gain: ≥40 dB

(3) Noise figure: ≤2.0 dB

(4) Output standing wave (VSWR): ≤2.0

(5) In-band flatness: ±2 dB

(6) Operation voltage: 5 VDC

(7) Operation current: ≤60 mA@5V

(8) Interface: SMA.

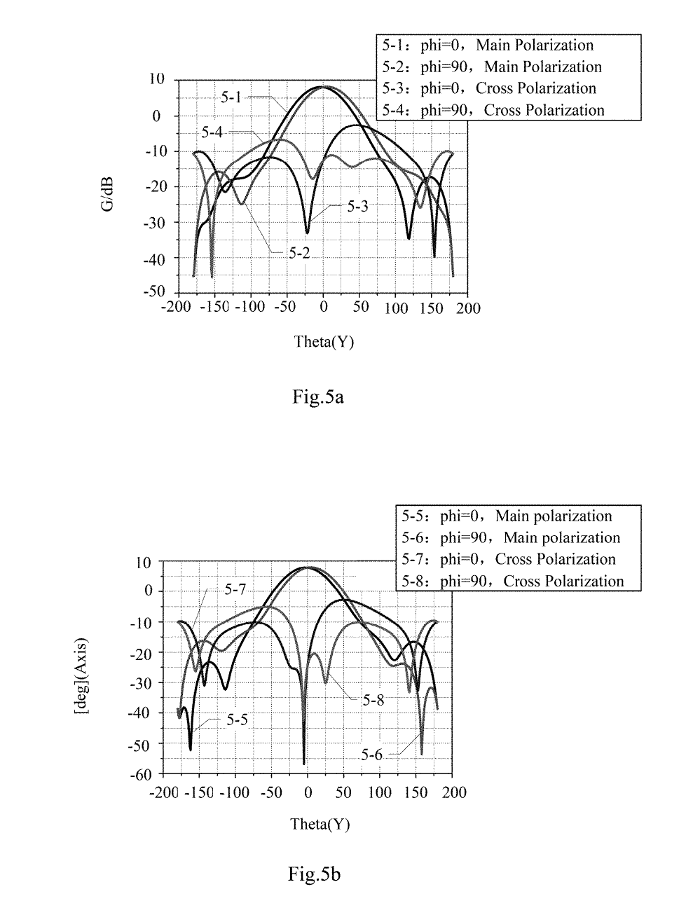

Correspondingly, for the GNSS signal receiving antenna adopting the above indexes, the frequency characteristic diagram of its S11 port is shown in FIG. 4 and the patters obtained from testing of the antenna are shown in FIGS. 5a-5c. FIG. 5a is a pattern of the antenna for a main polarization directional wave and a cross polarization directional wave with respect to an electromagnetic wave with a frequency of 1.19 GHz. FIG. 5b is a pattern of the antenna for a main polarization directional wave and a cross polarization directional wave with respect to an electromagnetic wave with a frequency of 1.26 GHz. FIG. 5c is a pattern of the antenna for a main polarization directional wave and a cross polarization directional wave with respect to an electromagnetic wave with a frequency of 1.575 GHz. It can be known according to FIGS. 5a-5c that the antenna of the present embodiment can have a larger gain for the main polarization directional wave in all directions and suppress the influence of the cross polarization waves at the same time in the above frequency bands.

Thus, in the embodiment, an omnidirectional GNSS signal receiving antenna is obtained by arranging the radiation pattern as four sub-patterns that form a rectangular shape and the end portion of the third part of each sub-pattern is disposed opposite to a side portion of the first part of a next adjacent sub-pattern, and the antenna can receive both a traditional right-handed circularly polarized signal and a left-handed circularly polarized signal.

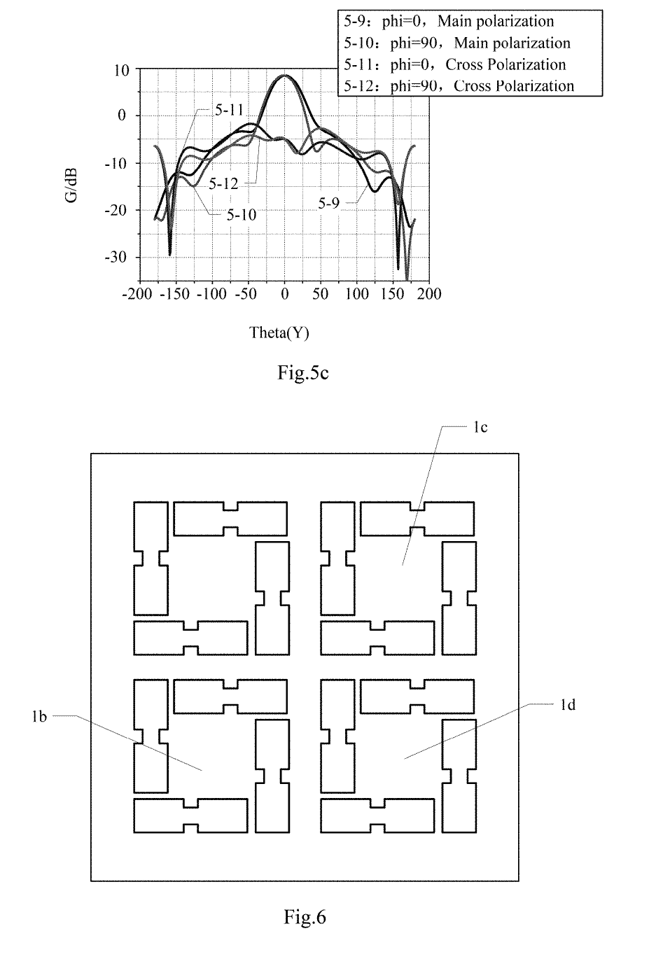

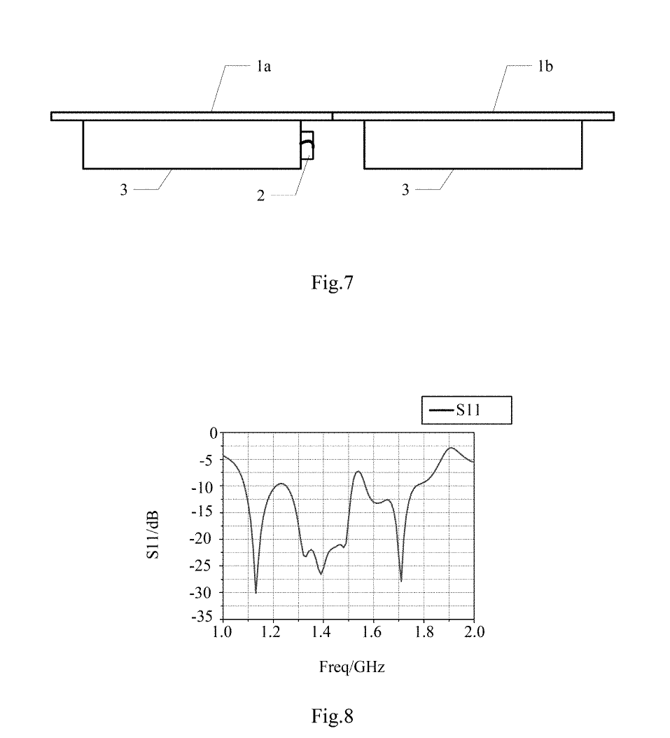

FIGS. 6 and 7 are respectively a front view and a side view of a GNSS signal receiving antenna according to a second embodiment of the present disclosure.

As shown in FIG. 6 and FIG. 7, the GNSS signal receiving antenna of the present embodiment comprises four antenna units 1a-1d arranged in an array, a low noise amplifier 2 and a support component 3. In the present embodiment, the antenna units 1a-1d form an array antenna with two rows and two columns.

The way of arranging the radiation pattern and the feed pattern for each of the antenna units 1a-1d is the same as that of the first embodiment and will not be repeated here. It should be noted that, in the present embodiment, the radiation patterns and the feed patterns of the antenna units 1a-1d may be formed on a same substrate, that is, the four antenna units 1a-1d share the same substrate. Alternatively, the radiation patterns and feed patterns of the antenna units 1a-1d can also be formed on different substrates, for example, a separate substrate is used for each antenna unit.

The low-noise amplifier 2 can be mounted on a side of the support member 3 to draw out signals received by the antenna units 1a-1d.

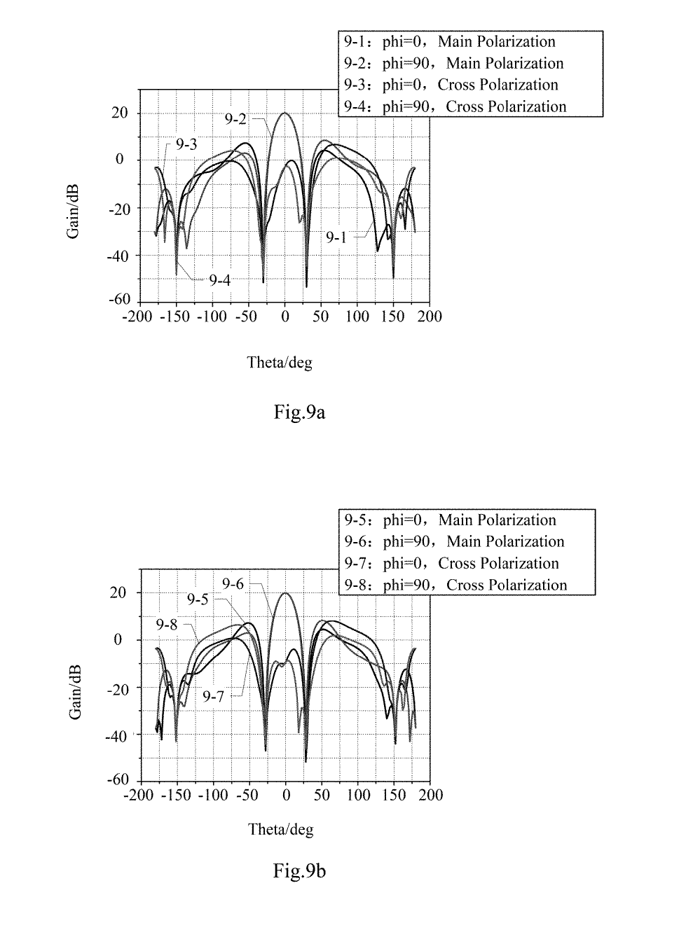

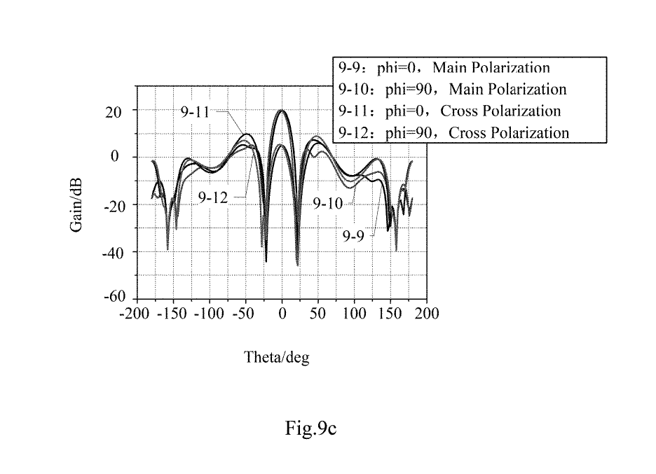

By using multiple antenna units arranged in an array, the directionality of the antenna can be adjusted by adjusting the feed phases of the signals received by different antenna units, so that the GNSS signal receiving antenna of the present embodiment can realize directionality characteristic and receive the GNSS signals directionally. For the GNSS signal receiving antenna of the present embodiment, the frequency characteristic diagram of its S11 port is shown in FIG. 8 and the patterns obtained from the testing of the antenna are shown in FIGS. 9a-9c. FIG. 9a is a pattern of the antenna for a main polarization directional wave and a cross polarization directional wave with respect to an electromagnetic wave with a frequency of 1.19 GHz. FIG. 9b is a pattern of the antenna for a main polarization directional wave and a cross polarization directional wave with respect to an electromagnetic wave with a frequency of 1.26 GHz. FIG. 9c is a pattern of the antenna for a main polarization directional wave and a cross polarization directional wave with respect to an electromagnetic wave with a frequency of 1.575 GHz. It can be known according to FIGS. 9a-9c that the antenna of the embodiment can have a larger gain for the main polarization directional wave in the main direction and suppress the influence of the cross polarization waves at the same time in the above frequency bands and has a good directionality.

What are described above are only preferred embodiments of the present disclosure, which are not intended to limit the present invention. To those skilled in the art, the present invention may have various alternations and changes. Any modifications, equivalent replacements, and improvements made within the spirit and principle of the present invention should be included within the protection scope of the present disclosure.

What is claimed is:

1. A GNSS signal receiving antenna comprising:
at least one antenna unit, wherein the antenna unit comprises: a substrate; a radiation pattern formed on a first surface of the substrate, including four sub-patterns that forms a rectangular shape; and a feed pattern formed on a second surface of the substrate;
a low-noise amplifier connected to the feed pattern of the antenna unit;
wherein each of the sub-patterns comprises a first part, a second part and a third part communicated with each other, the first part is communicated with the second part and the second part is communicated with the third part, the first part and the third part are symmetrically disposed with respect to the second part and have an identical rectangular shape, an end portion of the third part of each sub-pattern is disposed opposite to a side portion of the first part of a next adjacent sub-pattern so that the four sub-patterns form a rectangular shape, and the four sub-patters are not communicated with each other.

2. The GNSS signal receiving antenna of claim 1, wherein the second part has a rectangular shape.

3. The GNSS signal receiving antenna of claim 2, wherein a width of the second part is less than that of the first part and the third part.

4. The GNSS signal receiving antenna of claim 1, wherein the axes of the first part, the second part and the third part of the sub-pattern are arranged in a line.

5. The GNSS signal receiving antenna of claim 1, wherein the feed pattern is at least partially disposed at a position corresponding to an underside of the first part of each sub-pattern.

6. The GNSS signal receiving antenna of claim 1, wherein the sub-patterns are hollow out patterns, and the feed pattern is a conductive pattern.

7. The GNSS signal receiving antenna of claim 1, wherein the antenna comprises one said antenna unit and is an omnidirectional antenna.

8. The GNSS signal receiving antenna of claim 1, wherein the antenna comprises four said antenna units arranged in an array and is a directional antenna.
